(19) United States
(12) Patent Application Publication
(10) Pub. No.: US 2018/0258778 A1
(43) Pub. Date: Sep. 13, 2018

(54) NON-AXIALLY SYMMETRIC TRANSITION DUCTS FOR COMBUSTORS

(71) Applicant: SIEMENS AKTIENGESELLSCHAFT, München (DE)

(72) Inventors: Jacob William Hardes, Charlotte, NC (US); Manish Kumar, Charlotte, NC (US); Timothy A. Fox, Hamilton, Ontario (CA)

(21) Appl. No.: 15/571,139

(22) PCT Filed: Aug. 28, 2015
(86) PCT No.: PCT/US2015/047320

§ 371 Date: Nov. 1, 2017

(51) Int. Cl. F01D 9/02; F02C 3/14

(52) U.S. Cl. CPC F01D 9/023; F05D 2250/73; F05D 2240/35; F02C 3/14

(57) ABSTRACT

A gas turbine engine has a non-axially symmetric main duct portion (113). The non-axially symmetric main duct portion (113) may provide improved aerodynamics, heat load, structural strength and engine compactness.

### BACKGROUND

### 1. Field

Disclosed embodiments are generally related to gas turbine combustors and, more particularly to the structure of transition ducts.

### 2. Description of the Related Art

Previously annular gas turbine engines included several individual combustor cans disposed radially outside of and axially aligned with a rotor shaft. Combustion gases produced in these combustor cans were guided radially inward and then transitioned to axial movement by a transition duct. Turning vanes then received the combustion gases, accelerated the gases and directed the gases for delivery into a first stage of turbine blades.

In these gas turbine combustors an integrated exit piece (IEP) design had been used. In the IEP design, the transition ducts would merge to form a converging flow junction (CFJ). FIG. 1 shows a CFJ transition duct 10 that had been used to form the CFJ junction. The CFJ transition duct 10 has a primary opening 11 located at the main casting duct portion 12 and a secondary opening 17 located at the top sheet duct portion 14. The CFJ transition duct 10 was constructed by being cast as a unitary piece. Additionally shown in FIG. 1 is the flange 16 and circular flange 19 which have bolt holes 13 formed therein. The bolt holes 13 are used to interconnect the IEPs of the combustors.

CFJ transition duct 10 has been cooled via a pattern of ribs 18 supported on the outside surface of the main casting duct portion 12 and the top sheet duct portion 14. The manner in which the ribs 18 cooled the CFJ transition duct 10 created stress challenges in the connection between the main casting duct portion 12 and the top sheet duct portion 14. Furthermore, high stresses would occur at the central notch 15.

The stress challenges created by the geometry of the CFJ duct 10 and the manner in which the CFJ transition ducts 10 were connected resulted in limitations with respect to the structural integrity of the ducts themselves and the connection of the main casting duct portions 12 around the gas turbine engines.

To overcome this problem trailing edge ducts were developed. However, additionally in order to maximize the efficiency of the transition duct the shapes of portions of the trailing edge duct were improved.

### SUMMARY

Briefly described, aspects of the present disclosure relate to trailing edge ducts used with gas turbine combustors.

An aspect of the disclosure is a trailing edge duct having a main duct portion having a primary opening and a secondary opening. A first axis extends from a center of the primary opening to the secondary opening. An extension flange is connected to the main duct portion, wherein the main duct portion and the extension flange form a trailing edge. The main duct portion is non-symmetrical about an entire length first axis.

Another aspect of the disclosure is an apparatus for use in gas turbine engines. The apparatus has a main duct portion having a primary opening and a secondary opening, wherein a first axis extends from a center of the primary opening to the secondary opening. The main duct portion is non-symmetrical about an entire length of the first axis.

Still yet another aspect of the disclosure is a gas turbine engine comprising a first main duct portion having a first primary opening and a first secondary opening, wherein a first axis extends from a center of the first primary opening to the first secondary opening. The first main duct portion is non-symmetrical about an entire length of the first axis. The gas turbine engine also comprises a second main duct portion having a second primary opening and a second secondary opening, wherein a second axis extends from a center of the second primary opening to the second secondary opening; and wherein the second main duct portion is non-symmetrical about an entire length of the second axis.

### BRIEF DESCRIPTION OF THE DRAWINGS

FIG. 1 shows a prior art view of a converging flow junction transition duct.

FIG. 2 shows a trailing edge duct.

FIG. 3 shows a ring of trailing edge ducts.

FIG. 4 shows a side isometric view of a non-axially symmetric main duct portion.

FIG. 5 shows a front view of a non-axially symmetric main duct portion.

FIG. 6 is a simplified side view of a non-axially symmetric main duct portion, showing the throat.

FIG. 7 shows a velocity profile of the non-axially symmetric main duct portion.

FIG. 8 shows a view of the non-axially symmetric main duct portion with an extension flange.

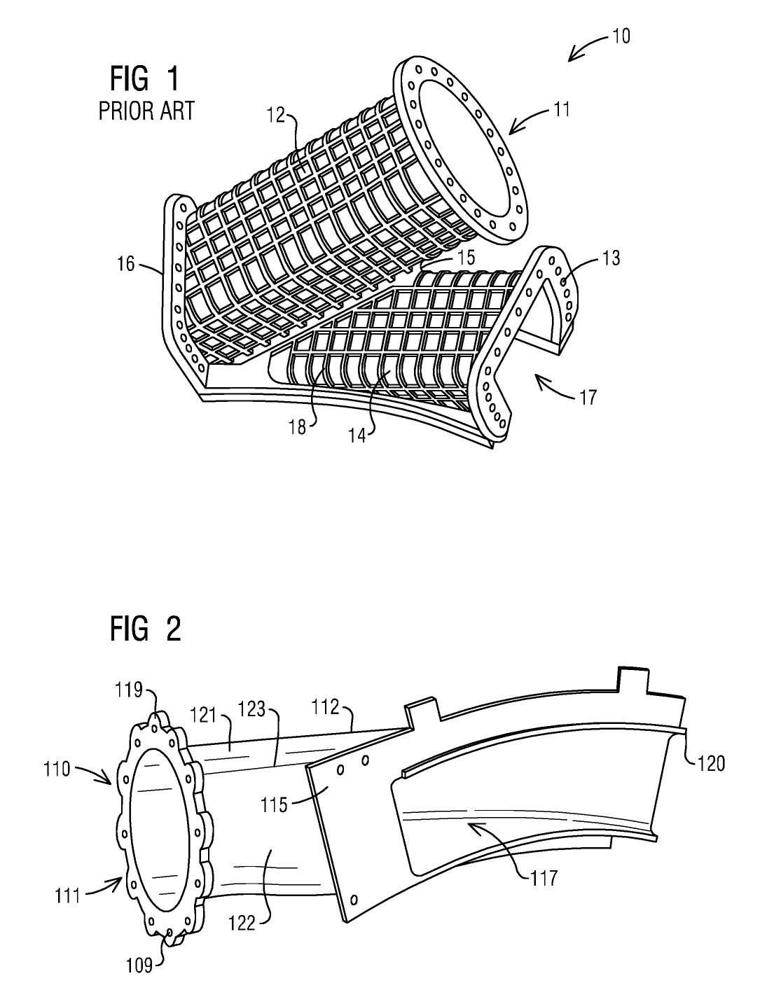

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

FIG. 2 shows a trailing edge duct 110 with which aspects of the present invention can be employed. The trailing edge duct 110 has a main duct portion 112 having a primary opening 111 and secondary opening 117. The main duct portion 112 may be formed of more than one panel, for example the main duct portion 112 shown in FIG. 2 is formed from a first main panel portion 121 and a second main panel portion 122 that are joined at a seam 123 via welding. The primary opening 111 receives fluids during operation in gas turbine engines. Located at and surrounding the primary opening 111 is an annular flange 119 having through holes 109 located therein. Located at the secondary opening 117 is an extension flange 115. The extension flange 115 and the main duct portion 112 together form the trailing edge 120 of the trailing edge duct 110.

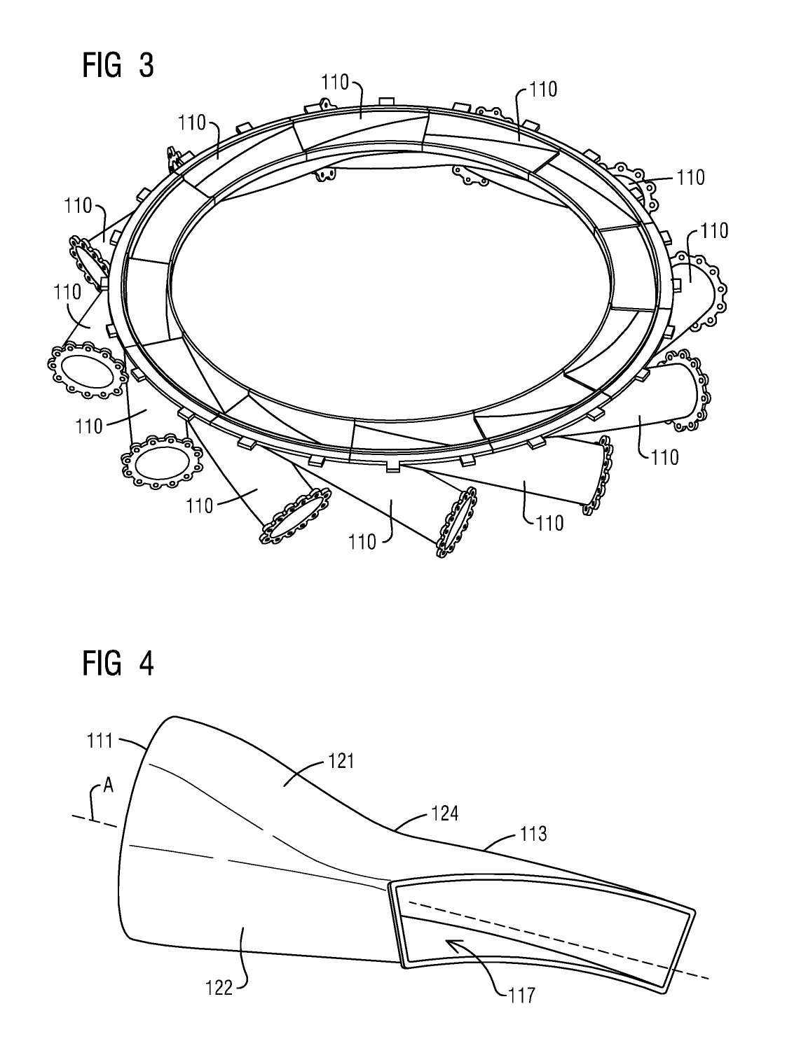

FIG. 3 shows the connection of the trailing edge ducts 110 in order to form a ring, in doing so the trailing edges 120 of the trailing edge ducts 110 are connected together so that one trailing edge duct 110 is connected to another.

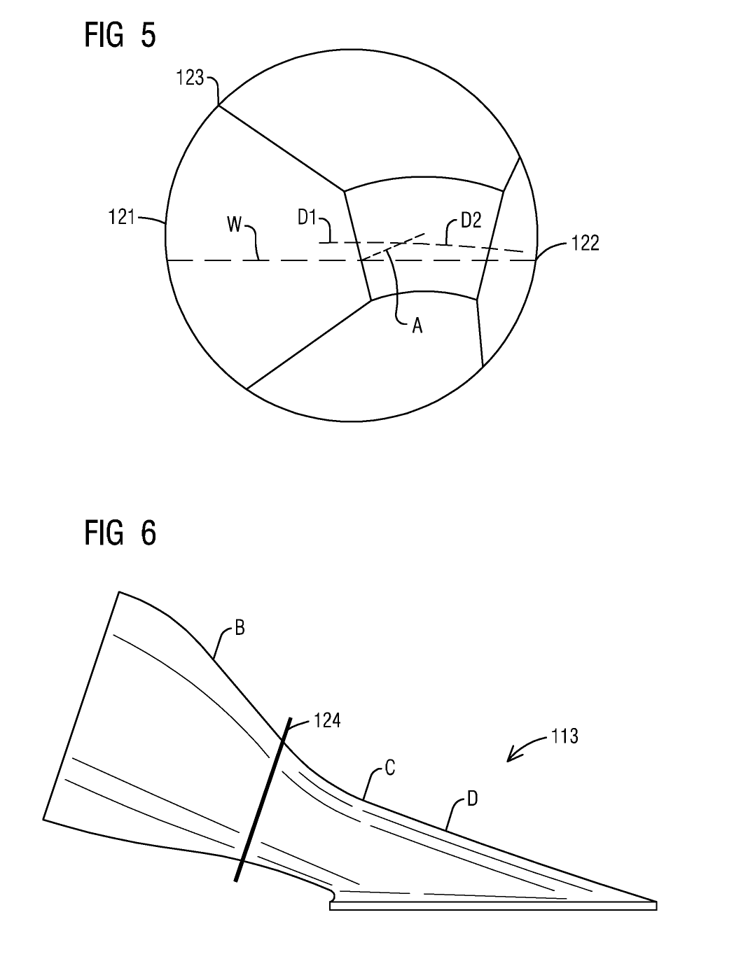

FIGS. 4 and 5 show the non-axially symmetric (NAS) main duct portion 113 that may be used instead of the main duct portion 112 shown in FIG. 2. The NAS main duct portion 113 is formed from a first main panel portion 121 and a second main panel portion 122 joined by a seam 123. The seam 123 may be formed by welding the first main panel portion 121 and the second main panel portion 122 together. The first main panel portion 121 and the second main panel portion 122 for the NAS main duct portion 113 have a length L.

A primary opening 111 is formed at one distal end of the NAS main duct portion 113 and a secondary opening 117 is formed at the opposite end of the NAS main duct portion 113. The primary opening 111 is circular and a first axis A extends along the length L of the NAS main duct portion 113 from the center of the primary opening 111 to the secondary opening 117. The secondary opening 117 is a curved rectangular shape that may form an arc. The formed arc may be preferably within the range of 20-45°. However, it should be understood that other angles may be used depending on the ultimate shape of the NAS main duct portion 113. The NAS main duct portion 113 narrows in width W as it extends along its length L from the primary opening 111 to the secondary opening 117. While, the width W generally decreases along the length L, in some locations the width may vary. The narrowing may begin at the throat 124 of the NAS main duct portion 113. The throat 124 may also be the location where the circular shape transitions into a more rectangular shape.

As shown in FIG. 5, the distance D1 from a wall of the first main panel portion 121 to the axis A is less than the distance D2 taken from a wall of the second main panel portion 122 to the axis A at the same point and extending directions opposite from each other. A distance, such as D1 or D2, is taken in a direction orthogonal to the direction in which the axis A extends. Typically the distance D1 is different than the distance D2 at a location taken from the same point on the axis A. Having different distances D1 and D2 makes the general shape of the NAS main duct portion 113 non-axially symmetric. Also the distance D1 may increase as well as decrease as it is taken throughout the length of the main duct portion 113 from the primary opening 111 to the secondary opening 117. For example, in FIG. 6 the distance at point B from the axis A is greater than the distance at point C from the axis A, while the distance at point D is greater than the distance at point C but less than the distance at point B.

Generally speaking, the NAS main duct portion 113 is non-symmetrically conical throughout its length L, which is to say the NAS main duct portion 113 resembles a conical structure but does not have the symmetry that a cone has. This differs from the main duct portion 112 shown in FIG. 2 which is conical throughout a substantial portion of its length. Thus the NAS main duct portion 113 is able to be adapted to more complex geometries.

A non-asymmetric shape such as that of the NAS main duct portion 113 is complicated to manufacture and develop. However the shape of the main duct portion will also affect other performance parameters.

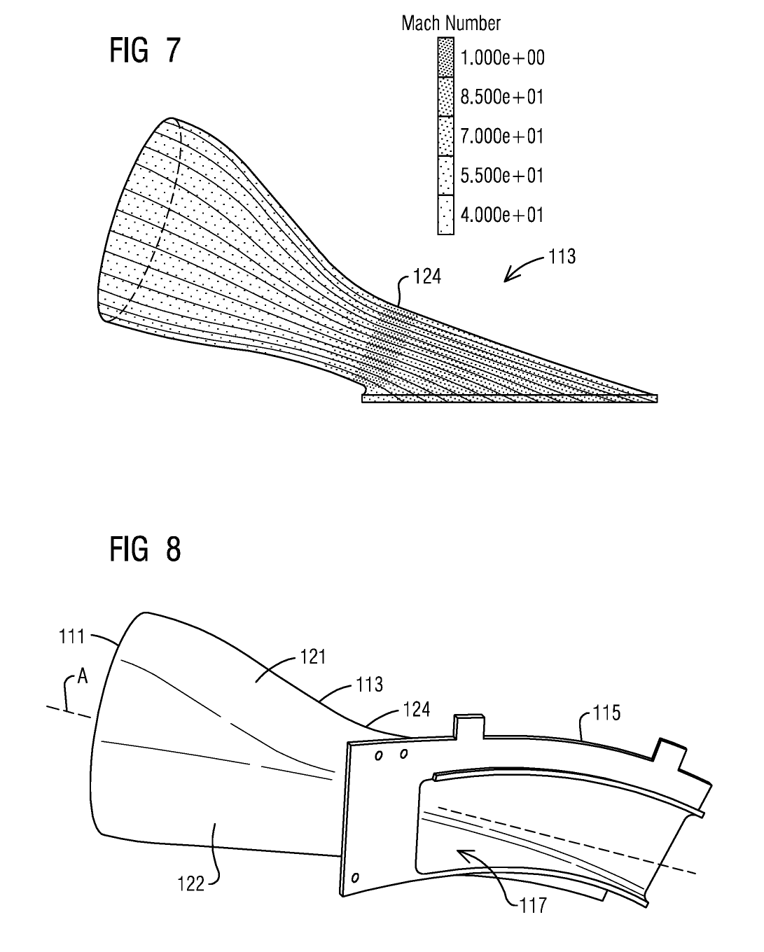

First, the shape of the NAS main duct portion 113 will impact the internal aerodynamics. Turning to FIGS. 6 and 7, shown is a simplified side view of the NAS main duct portion 113, showing the throat 124 and a velocity profile of the NAS main duct portion 113, respectively. Specifically, the velocity profile at the throat 124 can affect both the average flow angle and the variation around the average flow angle of the NAS main duct portion 113. In previous duct portions, if the flow entering the duct portion is uniform, then as the main duct portion opens into the turbine, the turning angle of the flow changes across the duct portion as more and more air dumps into the turbine. Thus the flow has a tendency to under turn. The NAS main duct portion 113 can be used to the make the distribution of flow into the open portion non-uniform and overcome the tendency to under turn. As shown in FIG. 7, the flow within the throat 124 has more uniform velocity.

The NAS main duct portion 113 reduces the amount of metal exposed to the hot air flow and as a result may have less use less cooling air than other types of ducts. For example, the total hot surface area of the NAS main duct portion 113 and extension flange 115 (shown below in FIG. 8), may be less than 0.7 m². The area-average heat transfer coefficient for the NAS main duct portion 113 and extension flange 115 may be less than 1100 W/m²K. The total heat flux per degree K for the NAS main duct portion 113 and the extension flange 115 is less than 1200 W/K.

Second the mid-frame aerodynamics of the combustor can be impacted. The main combustor inlet air has to pass through transition ducts to fill the turbine side of the combustor basket. Creating a greater gap between adjacent transition ducts is beneficial. This is because the mid-frame aerodynamics will also affect the passive external heat transfer coefficient distribution on the external surfaces of the NAS main duct portion 113. This has a similar effect as active cooling requirements. By making the gaps between adjacent NAS main duct portions 113 relatively uniform and, for example, 2.5 cm apart, a high speed air flow on the outside of the NAS main duct portion 113 can be obtained. This is in contrast to other configurations of ducts that may have many regions of high and low speed flow. Creating a predictable high speed air flow reduces the need for cooling air. For example 95% of midframe air.

Third, the heat load of the NAS main duct portion 113, and by extension, the total cooling air consumption of the gas turbine engine can be improved by the non-axial symmetric shape of the NAS main duct portion 113. It is beneficial to minimize the hot-side surface area of the NAS main duct portion 113 by making the NAS main duct portion 113 as compact as possible. The length of NAS main duct portion 113 taken from the primary opening 111 of the NAS main duct portion 113 to the trailing edge 120 is approximately the same size as the combustor basket.

Fourth, the NAS main duct portion 113 may be used to impact the compactness of the combustor. The assembly of the combustor can be shortened and the combustors can be pulled back inside the gas turbine engine. The overall casing diameter for the gas turbine engine can also be reduced thus further reducing overall costs. The overall casing diameter can also be decreased, which decreases overall engine cost. Further the axis of the engine can be lowered which reduces plant costs by reducing the size of the enclosure and improves stability by reducing the size of the support legs. Additionally use of the NAS main duct portion 113 may be used to provide additional structural strength. A long transition from circular shape to a square shape may create some relatively flat sections which are prone to collapse due to pressure loading. By providing a compact shape for the NAS main duct portion 113, when transitioning from round to square, the compact shape assists in making a majority of the NAS main duct 113 have positive curvature (convex), which is highly resistant to pressure loads.

FIG. 8 shows a view of the NAS main duct portion 113 with an extension flange 115. It should be understood that the NAS main duct portion 113 may be used in embodiments that do not employ an extension flange 115 and form a trailing edge duct 110.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

1. A trailing edge duct comprising:
a main duct portion having a primary opening and a secondary opening, wherein a first axis extends from a center of the primary opening to the secondary opening;
an extension flange connected to the main duct portion, wherein the main duct portion and the extension flange form a trailing edge; and
wherein the main duct portion is non-symmetrical along an entire length of the first axis.

2. The trailing edge duct of claim 1, further comprising a first main panel portion and a second main panel portion , wherein a first distance from a point on the first axis to the first main panel portion is less than a second distance from the same point on the first axis to the second main panel portion.

3. The trailing edge duct of claim 1, further comprising a seam formed between a first main panel portion and a second main panel portion.

4. The trailing edge duct of claim 1, wherein the primary opening is circular and the secondary opening is rectangular.

5. The trailing edge duct of claim 1, wherein a distance to the first axis increases and decreases along the length of the first axis.

6. The trailing edge duct of claim 1, wherein the secondary opening is arced from between 25°-45°.

7. The trailing edge duct of claim 1, wherein the main duct portion narrows in width (W) as it extends along its length (L) from the primary opening to the secondary opening.

8. The trailing edge duct of claim 1, wherein the main duct portion further comprises a throat, wherein the throat is adapted to provide a substantially uniform airflow.

9. An apparatus for use in gas turbine engines comprising:
a main duct portion having a primary opening and a secondary opening, wherein a first axis extends from a center of the primary opening to the secondary opening;
wherein the main duct portion is non-symmetrical along an entire length of the first axis.

10. The apparatus of claim 9, further comprising a first main panel portion and a second main panel portion, wherein a first distance from a point on the first axis to the first main panel portion is less than a second distance from the same point on the first axis to the second main panel portion.

11. The apparatus of claim 9, further comprising a seam formed between a first main panel portion and a second main panel portion.

12. The apparatus of claim 9, wherein the primary opening is circular and the secondary opening is rectangular.

13. The apparatus of claim 9, wherein the secondary opening is arced from between 25°-45°.

14. The apparatus of claim 9, wherein the main duct portion narrows in width (W) as it extends along its length (L) from the primary opening to the secondary opening.

15. A gas turbine engine comprising:
a first main duct portion having a first primary opening and a first secondary opening, wherein a first axis extends from a center of the first primary opening to the first secondary opening; wherein the first main duct portion is non-symmetrical along an entire length of the first axis;
and a second main duct portion having a second primary opening and a second secondary opening, wherein a second axis extends from a center of the second primary opening to the second secondary opening; wherein the second main duct portion is non-symmetrical along an entire length of the second axis.

16. The gas turbine engine of claim 15, further comprising a seam formed between a first main panel portion and a second main panel portion.

17. The gas turbine engine of claim 15, wherein a distance to the first axis increases and decreases along the length of the first axis.

18. The gas turbine engine of claim 15, further comprising a first main panel portion and a second main panel portion, wherein a first distance from a point on the first axis to the first main panel portion is less than a second distance from the same point on the first axis to the second main panel portion.

19. The gas turbine engine of claim 15, wherein the main duct portion narrows in width (W) as it extends along its length (L) from the primary opening to the secondary opening.

20. The gas turbine engine of claim 15, wherein the main duct portion further comprises a throat , wherein the throat is adapted to provide a substantially uniform airflow.
